(19) United States
(12) Patent Application Publication
(10) Pub. No.: US 2020/0178709 A1
(43) Pub. Date: Jun. 11, 2020

(54) CUSTOMIZABLE, ATTACHABLE TRAVEL PILLOW

(71) Applicant: Mathew Chase Brown, Plano, TX (US)

(72) Inventor: Mathew Chase Brown, Plano, TX (US)

(21) Appl. No.: 16/293,636

(22) Filed: Mar. 6, 2019

Related U.S. Application Data
(60) Provisional application No. 62/638,867, filed on Mar. 5, 2018.

(51) Int. Cl. A47G 9/10; A47G 9/02; A47G 9/04; G09F 23/00

(52) U.S. Cl. CPC A47G 9/10; G09F 23/00; A47G 9/04; A47G 9/0253

(57) ABSTRACT

Provided is a travel pillow that includes a washable, outer casing that includes a removable carabiner attachable to the washable, outer casing, a zipper sown along an elongated side of the washable, outer casing, and an inner pocket sewn to an inner side of the washable, outer casing along at least an inner portion of the zipper; an inner, sealed casing filled with malleable filling substantially in the shape of a cylindrical body; wherein the washable, outer casing is customizable with a combination of one or more of text, a logo, or an image; the washable, outer casing is filled with the inner, sealed casing and takes the shape of a substantially cylindrical body; the inner, sealed casing is removable from the washable, outer casing through the zipper; the inner pocket is capable of receiving one or more objects comprising headphones, keys, cards, or cash.

This application claims the benefit of Provisional Patent Application No. 62/638,867, filed Mar. 5, 2017, which is hereby incorporated by reference.

### FIELD OF THE DISCLOSURE

This disclosure relates to a customizable, attachable, washable, travel pillow with a removable cover with a zipper and a storage cavity for receiving objects.

### BACKGROUND

Many travelers, such as athletes, students, and the like, have the need to carry a pillow that is easily recognizable, substantially light, mobile, and attachable to objects such as backpacks or other bags or devices. The available pillows in the market do not provide for a pillow that can be easily washed and includes a storage cavity, such as an inner pocket for putting headphones and other devices. As such the need exists for a customizable, attachable, washable, travel pillow.

### SUMMARY

The following presents a simplified summary of some embodiments of the devices described herein in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

In some embodiments a washable, outer casing is presented which includes a removable carabiner attachable to the washable, outer casing, a zipper sown along an elongated side of the washable, outer casing, and an inner pocket sewn to an inner side of the washable, outer casing along at least an inner portion of the zipper, an inner, sealed casing filled with malleable filling substantially in the shape of a cylindrical body; wherein the washable, outer casing is customizable with a combination of one or more of text, a logo, or an image; the washable, outer casing is filled with the inner, sealed casing and takes the shape of a substantially cylindrical body; the inner, sealed casing is removable from the washable, outer casing through the zipper; the inner pocket is capable of receiving one or more objects comprising headphones, keys, cards, or cash.

In another embodiment a mobile, attachable body support device is presented that includes an inner casing filled with malleable filling, wherein the inner casing is substantially cylindrically shaped; a washable, removable, outer casing, wherein the outer casing is substantially cylindrically shaped and capable of receiving the inner casing through a fastening member, the fastening member disposed along an elongated side of the support device for removing the outer casing; an inner storage pocket capable of receiving objects, wherein the inner storage pocket is fastened to the washable, removable, outer casing along an inner portion of the fastening member; and a carabiner attachable to one end of the washable, removable, outer casing and attachable to objects for travel.

In yet another embodiment, washable, outer pillow casing is presented including a removable carabiner attachable to the washable, outer casing, a zipper sown along an elongated side of the washable, outer casing, and an inner pocket attached to an inner side of the washable, outer casing along at least an inner portion of the zipper, wherein the washable, outer casing is customizable with a combination of one or more of text, a logo, or an image; the washable, outer casing is capable of receiving malleable filling in substantially the shape of a cylindrical body through the zipper; and the inner pocket is capable of receiving one or more objects.

### BRIEF DESCRIPTION OF THE FIGURES

FIG. 1 is an embodiment of the pillow with casing unzipped, embodying features of the present invention.

FIG. 2 is an embodiment of the pillow with casing unzipped and the hidden pocket pulled out for better demonstration of the invention, embodying features of the present invention.

FIG. 3 is an embodiment of the pillow with customizable customized text, figure, and/or picture on the elongated side of the pillow casing

FIG. 4A is an embodiment of the pillow casing, embodying features of the present invention.

FIG. 4B is an embodiment of the pillow casing with the hidden pocket pulled out for better demonstration of the invention, embodying features of the present invention.

FIG. 5 is an embodiment of the pillow with storage cavity and showing usage of the storage cavity for small objects such as headphones.

FIG. 6 is an embodiment of the pillow attaching to a backpack with a carabiner.

FIG. 7 is an embodiment of the pillow, embodying features of the present invention.

FIG. 8 is an embodiment of the pillow, with casing unzipped and the hidden pocket inside the casing.

FIG. 9 is an embodiment of the pillow with casing zipped, showing customizable customized text, figure, and/or picture on the elongated side of the pillow casing and on the opposite side of the zipper.

### DETAILED DESCRIPTION OF SOME EMBODIMENTS

The present invention will now be described in detail with reference to a few embodiments thereof as illustrated in the accompanying drawings. In the following description, numerous specific details are set forth in order to provide a thorough understanding of the present inventions. It will be apparent, however, to one skilled in the art, that the present invention may be practiced without some or all of these specific details. In other instances, well known process steps and/or structures have not been described in detail in order to not unnecessarily obscure the present invention. Further, it should be emphasized that several inventive techniques are described, and embodiments are not limited to systems implanting all of those techniques, as various cost and engineering trade-offs may warrant systems that only afford a subset of the benefits described herein or that will be apparent to one of ordinary skill in the art.

Embodiments described herein introduce a new, original travel pillow that is customizable and can attach with a carabiner or other attachable device, such as hooks, strap buckles, or hoop and loop fasteners, to objects, such as a backpack, athletic bags, and/or other luggage. In some embodiments, the carabiner and/or attachable device may be removable if use of carabiner is not desired and may be replaced with a strap or other carrying handle. In such embodiments, the pillow may be used as a regular pillow, as a travel neck pillow, a neck roll, or for other similar uses. These uses may be made with other embodiments as well. In other embodiments, the carabiner and/or attachable device may be detached for washing, such as machine-washing.

In embodiments, casing of the travel pillow is customizable with text, such as a school or sports team names and/or logos or business names, and can be customizable to include different colors and/or textures depending on the choice and/or needs of the user. In other embodiments, the casing may be removed and replaced with a different casing. The casing includes a zipper or other fastener for accessibility to the filling. In other embodiments, the cover may be removed for washing. In some embodiments, the cover includes one or more separate pockets for headphones, keys, cards, and/or other small objects. In some embodiments, the said pockets is on the outside surface of the pillow casing. While in other embodiment, the said pockets is on the inside surface of the casing, keeping the pockets and its stored objects hidden from plain view. The pillow comprises malleable filling that allows for comfort anywhere, such as automobiles, train, plane, bus, chair, or conventional bed.

While this invention has been described in terms of several embodiments, there are alterations, permutations, and equivalents, which fall within the scope of this invention.

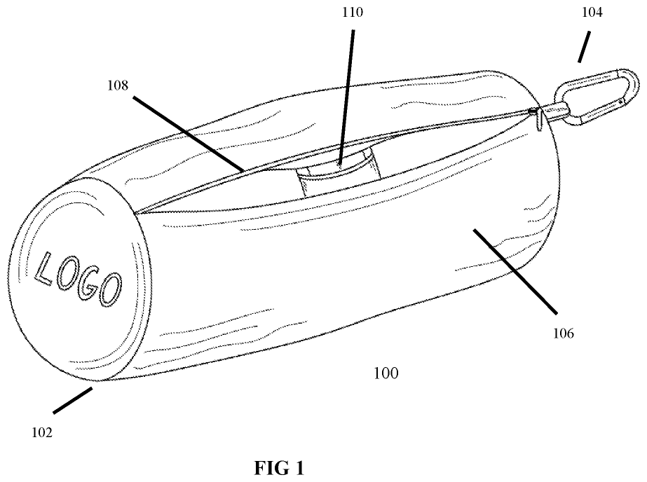

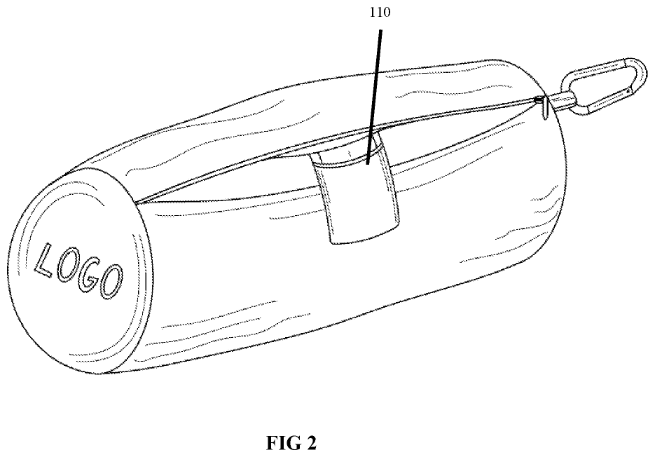

As shown in FIG. 1, travel pillow 100 is of a cylindrical shape, suitable for neck and body support in any environment. The travel pillow comprises a cylindrical body 102 and a fastening member 104. In the embodiment shown, the fastener member is a carabiner, but in other embodiments, the fastening member can be, but not limited to, a hook and loop fastener, a buckle strap, or an S-biner. Also, in one or more embodiments, the fastening member can be removed from the pillow for washing or cleaning.

The cylindrical body 102 comprise of a removable casing 106, which is in a cylindrical shape when filled with malleable filling. The removable casing have an opening 108 on the elongated side of the cylindrical shape that allows malleable filling to be removed if needed. In one or more embodiments, the opening 108 is a reclosable mouth, and the reclosable mouth can be, but not limited to, a zipper mouth or a button mouth. In one or more embodiments, the removable casing also have one or more pockets 110 on the outer and/or inner side of the casing, which can be used to store small objects such as keys, headphones, or cards.

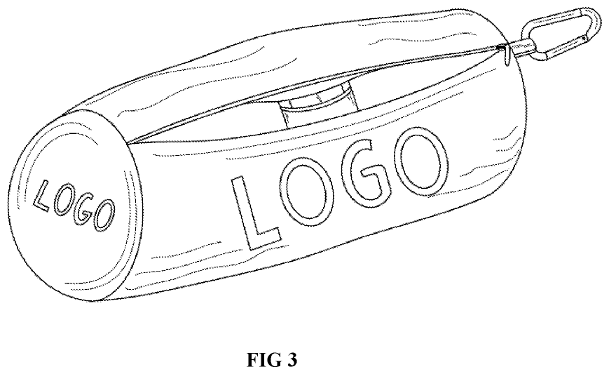

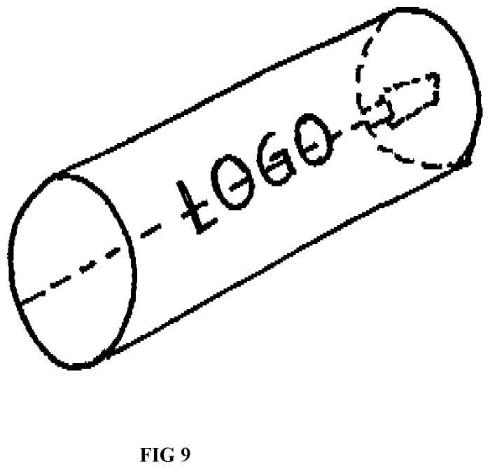

In one or more embodiments, the removable casing 106 consist of washable material, which allows the casing to be removed and washed if desired. In one or more embodiments, the removable casing can be customized with text, figure, and/or picture. The customization makes the pillow a personal object or a suitable souvenir to hand out at various events. As shown in FIG. 3 and FIG. 9, in one or more embodiments, the customized text, figure, and/or picture can be on the ends of the cylindrical shape of the removable casing.

As shown in FIG. 3, in one or more embodiments, the customized text, figure, and/or picture can be on the elongated side of the cylindrical shape of the removable casing.

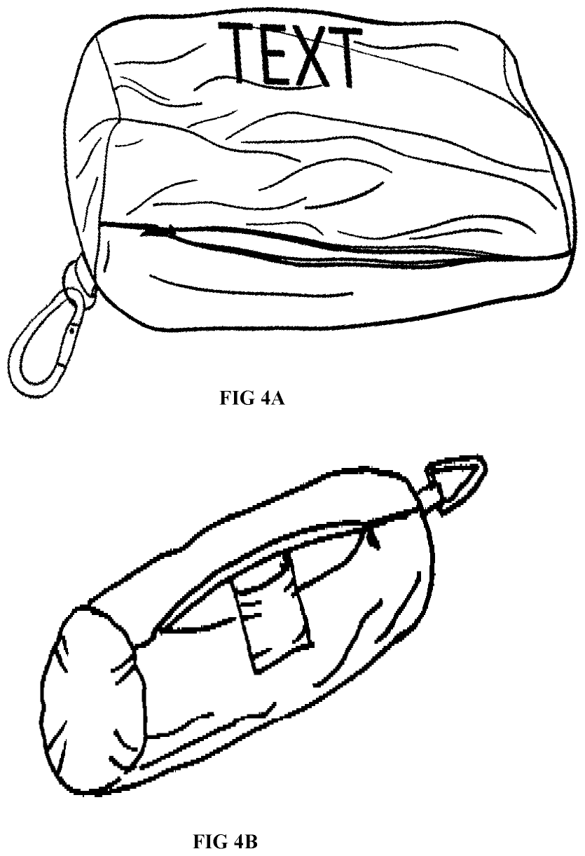

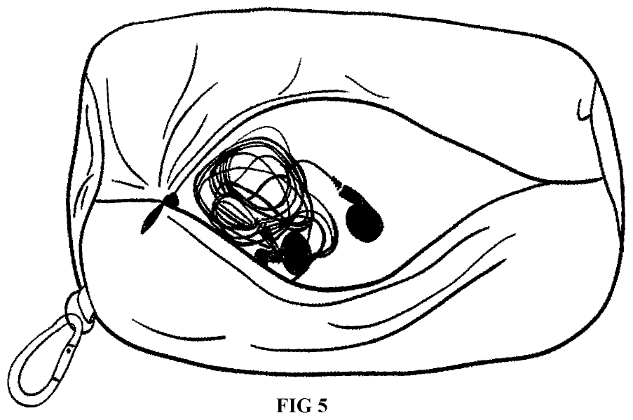

As shown in FIG. 4A and FIG. 4B the removable casing can be removed from the pillow, which allows the casing to be washed or replaced.

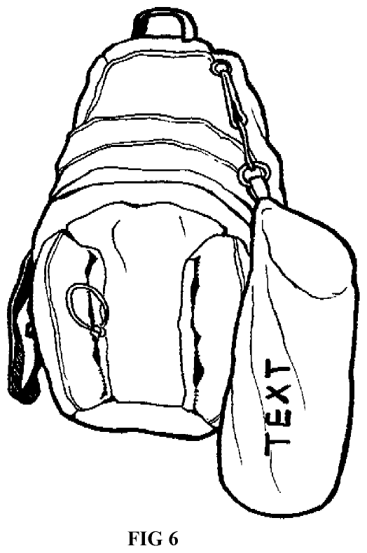

As shown in FIG. 6, by using the fastening member, the pillow can be attached to various objects, such as such as a backpack, athletic bags, and/or other luggage. This allows easy transportation of the pillow, making it ideal to be carried around while traveling

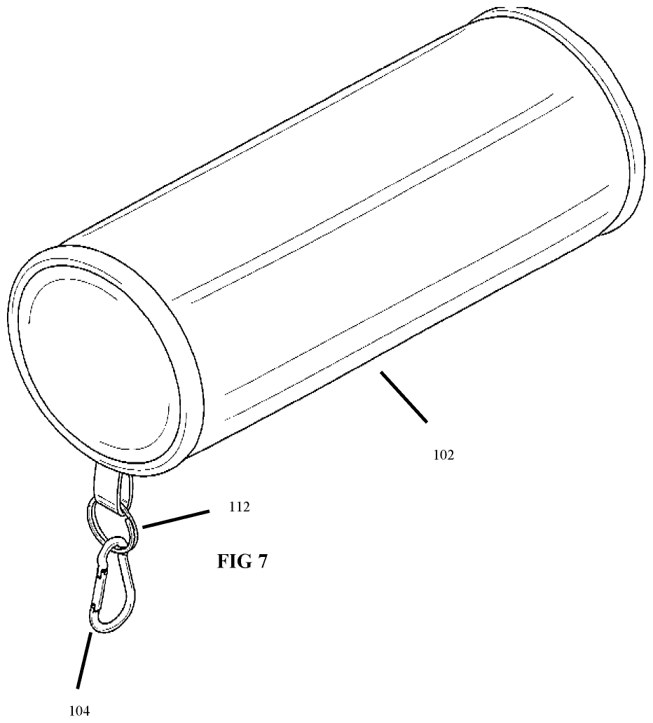

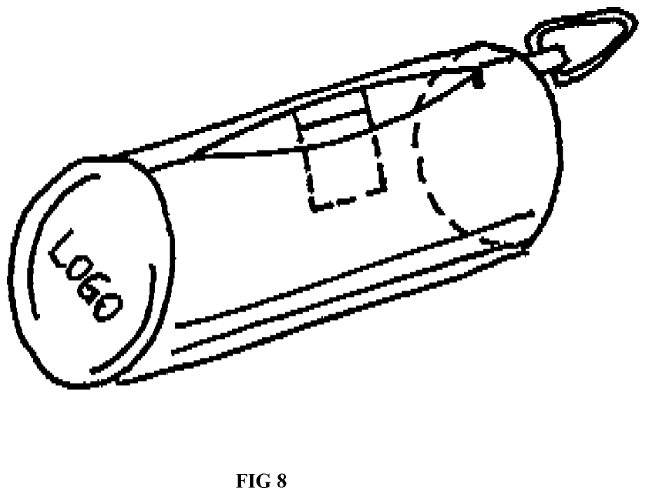

As shown in FIG. 7, in one or more embodiments, the fastening member is not directly attached to the cylindrical body. Instead, the fastening member is attached to a ring device 112, which is attached to the cylindrical body. In one or more embodiments, the ring device can be removed independently from the cylindrical body and the fastening member.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.”

The present techniques will be better understood with reference to the following enumerated claims.

What is claimed is:

1. A travel pillow attachable to objects comprising:
a washable, outer casing comprising:
a removable carabiner attachable to the washable, outer casing,
a zipper sown along an elongated side of the washable, outer casing, and
an inner pocket sewn to an inner side of the washable, outer casing along at least an inner portion of the zipper,
an inner, sealed casing filled with malleable filling substantially in the shape of a cylindrical body;
wherein
the washable, outer casing is customizable with a combination of one or more of text, a logo, or an image;
the washable, outer casing is filled with the inner, sealed casing and takes the shape of a substantially cylindrical body;
the inner, sealed casing is removable from the washable, outer casing through the zipper;
the inner pocket is capable of receiving one or more objects comprising headphones, keys, cards, or cash.

2. The travel pillow of claim 1, wherein the combination of one or more of text, logo, or image comprises text, logo, or image of athletic teams or business names.

3. The travel pillow of claim 1, wherein the malleable filling comprises microbeads.

4. The travel pillow of claim 1, wherein the carabiner is attachable to the washable, outer casing by a loop sewn to one end of the outer casing.

5. The travel pillow of claim 1, further comprising a handle attached to one end of the outer casing.

6. The travel pillow of claim 1, wherein the inner pocket is hidden from view when the zipper is closed.

7. The travel pillow of claim 1, wherein the outer casing is capable of receiving objects for storage.

8. A mobile, attachable body support device comprising:
an inner casing filled with malleable filling, wherein the inner casing is substantially cylindrically shaped;
a washable, removable, outer casing, wherein the outer casing is substantially cylindrically shaped and capable of receiving the inner casing through a fastening member, the fastening member disposed along an elongated side of the support device for removing the outer casing;
an inner storage pocket capable of receiving objects, wherein the inner storage pocket is fastened to the washable, removable, outer casing along an inner portion of the fastening member; and
a carabiner attachable to one end of the washable, removable, outer casing and attachable to objects for travel.

9. The device of claim 8, wherein the washable, removable, outer casing is customizable with at least one of text, a logo, or an image.

10. The device of claim 8, wherein the washable, removable, outer casing consist of machine-washable material.

11. The device of claim 8, wherein the objects receivable by the inner storage pocket comprise at least one of headphones, keys, cards, or cash.

12. The device of claim 8, further comprising one or more outer, sealable storage cavities attached to an outer portion of the washable, removable, outer casing.

13. The device of claim 8, wherein the carabiner is attached to the one end of the washable, removable, outer casing by a loop sown to the outer casing.

14. The device of claim 8, wherein the fastening member is one of a zipper, a buckle strap, or a plurality of buttons.

15. The device of claim 8, wherein the carabiner is attached to the one end of the washable, removable, outer casing by a ring attachable to a loop fastener.

16. The device of claim 8, further comprising a handle sewn to one end of the outer casing.

17. The device of claim 8, wherein the inner storage pocket is sealable.

18. The device of claim 8, wherein the malleable filling comprises microbeads and the washable, outer casing comprises a polyester blend.

19. A washable, outer pillow casing comprising:
a removable carabiner attachable to the washable, outer casing,
a zipper sown along an elongated side of the washable, outer casing, and
an inner pocket attached to an inner side of the washable, outer casing along at least an inner portion of the zipper,
wherein
the washable, outer casing is customizable with a combination of one or more of text, a logo, or an image;
the washable, outer casing is capable of receiving malleable filling in substantially the shape of a cylindrical body through the zipper; and
the inner pocket is capable of receiving one or more objects.

20. The washable, outer pillow casing of claim 19, further comprising an inner, sealed casing filled with malleable filling wherein the outer casing is capable of receiving the inner, sealed casing.
